(19) United States
(12) Patent Application Publication
(10) Pub. No.: US 2026/0214343 A1
(43) Pub. Date: Jul. 23, 2026

(54) IMAGE CAPTURING APPARATUS, CONTROL METHOD, AND STORAGE MEDIUM

(71) Applicant: CANON KABUSHIKI KAISHA, Tokyo (JP)

(72) Inventor: KOTARO TAKAHATA, Kanagawa (JP)

(21) Appl. No.: 19/433,357

(22) Filed: Dec. 26, 2025

(30) Foreign Application Priority Data
Jan. 22, 2025 (JP) 2025-008974

(51) Int. Cl. H04N 23/72; H04N 13/207; H04N 13/246; H04N 13/296; H04N 23/71; H04N 23/73; H04N 23/74

(52) U.S. Cl. CPC H04N 23/72; H04N 13/207; H04N 13/246; H04N 13/296; H04N 23/71; H04N 23/73; H04N 23/74

(57) ABSTRACT

In an image capturing apparatus, a light emission unit that emits pulsed light and an image capturing unit that generates at least first and second image signals having a predetermined parallax are provided, and a light emission time of the light emission unit and an exposure time of the image capturing unit are controlled so that the image capturing unit receives reflected light of the pulsed light within a predetermined distance range, a distance value to a subject and a reliability of the distance value are calculated based on at least the first and second image signals, and the light emission time of the light emission unit and the exposure time of the image capturing unit are controlled so as to change a size of the distance range of at least the first and second image signals generated by the image capturing unit, based on the reliability.

### BACKGROUND

### Field of the Technology

The present disclosure relates to an image capturing apparatus, a control method, a storage medium, and the like.

### Description of the Related Art

There is an image capturing method that uses a camera referred to as a range-gated camera. In the image capturing method, pulsed light is emitted toward the front of a camera for a predetermined period, and the image sensor inside the camera is exposed to only light reflected within a target distance range, whereby only a subject within the target distance range is captured clearly. It should be noted that, hereinafter, the above technology is referred to as “range-gating control.”

By this range-gating control, it is possible to clearly capture a subject located at a specific distance even under adverse weather conditions. Additionally, in range-gating control, by controlling the light emission time of the pulsed light, an exposure time of the camera, and an exposure timing, a distance range that can be captured in one exposure (hereinafter referred to as a “range width”) can be divided or integrated.

In a case in which range-gating control is performed by using an integrated range width, a captured image contains a large amount of stray light, so that a subject is captured indistinctly. However, since the number of distance divisions (hereinafter referred to as the “number of ranges”) when photographing the entire photographing range is small, the time until photographing of a desired distance range is completed can be shortened. As a result, object recognition processing can be executed at an early timing.

In contrast, in a case in which range-gating control is performed by using a divided range width, stray light is reduced, and a subject can be captured clearly, whereas the time until photographing of a desired distance range is completed is extended because the number of ranges increases.

For example, in Japanese Patent No. 6416085, an image acquired by range-gating control is analyzed, and in a case in which an image to be focused on, such as an image including a subject, is found as a result of the analysis, only the range width of the corresponding distance range is divided. Technology is described that enables a subject to be captured clearly while suppressing an extension of time required to photograph the entire photographing range.

Additionally, in recent years, stereo camera systems employing the triangulation method have been mounted on many automobiles as devices that measure a distance to a subject to realize Advanced Driver Assistance System (ADAS) functions. Examples of stereo camera systems include a binocular stereo camera system and a monocular stereo camera system (for example, an image-capturing surface phase-difference camera distance measuring system).

In a stereo camera distance-measuring system, two cameras are arranged in parallel at a predetermined interval, a shift amount due to parallax of a subject appearing in images captured by the respective cameras is calculated, and a distance to the subject is calculated based on the shift amount.

The image-capturing-surface phase-difference camera distance-measuring system performs imaging with a single camera provided with an imaging element referred to as an image-capturing-surface phase-difference element, and detects a shift amount due to parallax in an image signal generated when light having passed through an image-forming optical system enters a plurality of pixels formed on the imaging element. Thereafter, a distance to the subject is calculated based on the shift amount.

The distance-measuring camera system may be unable to accurately calculate a distance to a subject in adverse weather. Specifically, adverse weather refers to a state in which particles such as rain, fog, or snow hinder visibility of the subject.

In the above distance-measuring camera system, in a case in which diffusely reflected light by the particles located in front of the subject is captured by the camera, the subject cannot be captured clearly. Consequently, parallax cannot be calculated accurately, and the subject cannot be ranged with high accuracy.

In Japanese Patent No. 6,416,085, images acquired by range-gating control are analyzed, and in a case in which an image including a subject is present, only the range width of the corresponding distance range is divided. Thus, a subject is captured clearly while suppressing an extension of the time required to photograph the entire photographing range.

However, in the technology of Japanese Patent No. 6,416,085, since the range width is updated based on an image analysis result, there has been a drawback that image-analysis processing needs to be performed before range-width updating processing.

### SUMMARY

An image capturing apparatus according to one aspect of the present disclosure comprises a light emission unit that emits pulsed light and an image capturing unit that generates at least first and second image signals having a predetermined parallax are provided, wherein a light emission time of the light emission unit and an exposure time of the image capturing unit are controlled so that the image capturing unit exposes reflected light of the pulsed light within a predetermined distance range, a distance value to a subject and a reliability of the distance value are calculated based on at least the first and second image signals, and the light emission time of the light emission unit and the exposure time of the image capturing unit are controlled so as to change a size of the distance range of at least the first and second image signals generated by the image capturing unit, based on the reliability.

Features of the present disclosure will become apparent from the following description of embodiments with reference to the attached drawings. The following description of embodiments are described by way of example.

### BRIEF DESCRIPTION OF THE DRAWINGS

FIG. 1 is a functional block diagram illustrating an example configuration of a camera 100, a light emitter 200, and a moving object 300 according to a first embodiment.

FIG. 2A is a top view of a photoelectric conversion element 102 as viewed from a light-incident direction, and FIG. 2B is a cross-sectional view taken along line I-I′ of a pixel group 400 in FIG. 2A.

FIGS. 3A to 3D are diagrams illustrating a relation between a distance to a subject and incident light in an image-capturing-surface phase-difference scheme.

FIG. 4 is a diagram illustrating an example relation between travel of reflected light and exposure timing in range-gating control.

FIG. 5 is a diagram illustrating an example of emission and exposure (electric charge accumulation) control operations for one frame period in range-gating control.

FIG. 6A is a flowchart illustrating an example of processing in a control method according to the first embodiment.

FIG. 6B is a flowchart illustrating a subsequent processing example of FIG. 6A.

FIG. 7 is a diagram illustrating an example of a relation between a setting value k and a range width according to the first embodiment.

FIG. 8 is a diagram illustrating an example of division of a range width according to the first embodiment.

FIG. 9 is a diagram illustrating an example of a method for comparing parallax reliability in each distance range acquired by range-gated imaging at different setting values k.

FIG. 10 is a functional block diagram illustrating an example of the configuration of a camera 100, a light emitter 200, and a moving object 300 according to a second embodiment.

FIG. 11 is a flowchart illustrating an example of processing according to the second embodiment.

### DESCRIPTION OF THE EMBODIMENTS

Hereinafter, with reference to the accompanying drawings, favorable modes of the present disclosure will be described using Embodiments. In each diagram, the same reference signs are applied to the same members or elements, and duplicate description will be omitted or simplified.

### First Embodiment

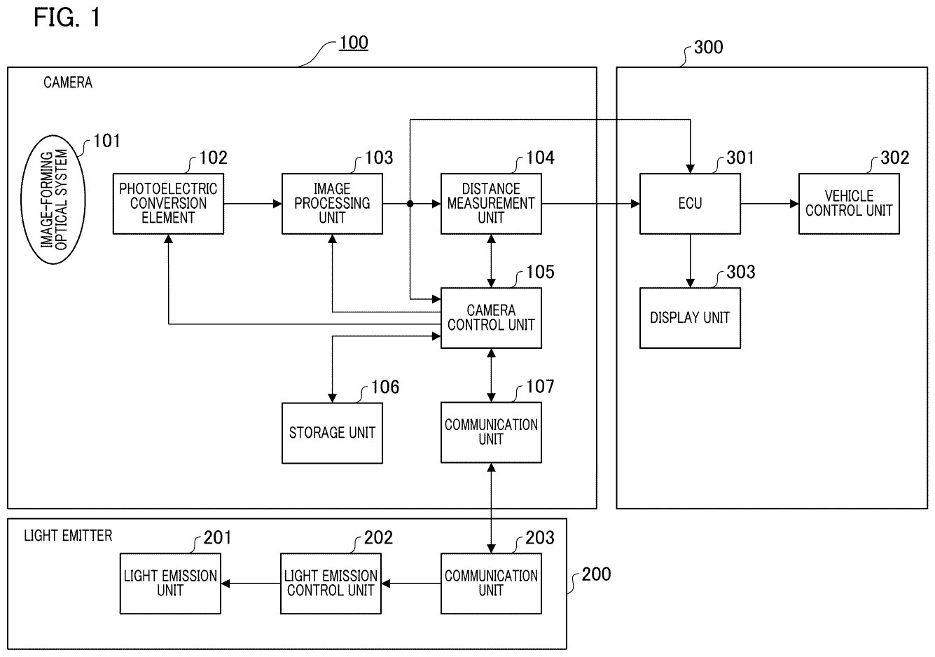

FIG. 1 is a functional block diagram illustrating an example of a configuration of a camera 100, a light emitter 200, and a moving object 300 according to the first embodiment. It should be noted that the camera 100 functions as an image capturing apparatus.

Additionally, in the present embodiment, an explanation will be given by using, as an example of the moving object 300, a vehicle such as an automobile. However, the moving object may be any movable device, such as a train, a ship, an airplane, a robot, a drone, an Automated Guided Vehicle (AGV), or an Autonomous Mobile Robot (AMR).

Note that a part of the functional blocks shown in FIG. 1 is realized by causing a computer (not illustrated) included in the camera 100, the light emitter 200, and the moving object 300 to execute a computer program stored in a memory serving as a storage medium (not illustrated).

However, some or all of the functional blocks may be realized by hardware. As hardware, an application-specific circuit (ASIC), a processor (reconfigurable processor, DSP) and the like can be used.

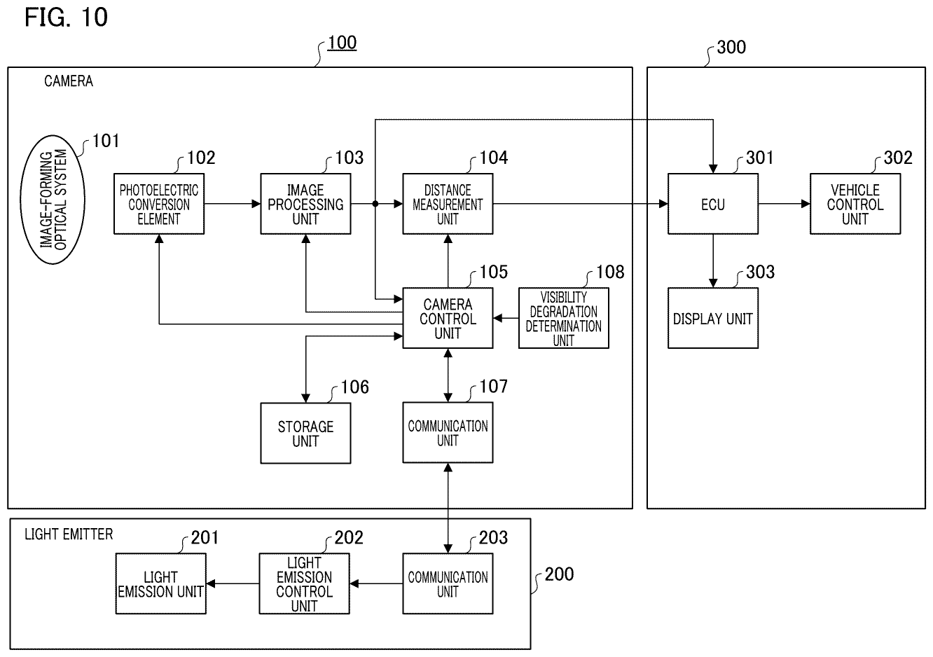

Additionally, the respective components shown in FIG. 1 do not need to be housed in the identical housing, and may instead be configured by separate devices connected to one another via a signal path. It should be noted that the above explanation regarding FIG. 1 applies similarly to FIG. 10.

The camera 100 includes an image-forming optical system 101, a photoelectric conversion element 102, an image processing unit 103, a distance measurement unit 104, a camera control unit 105, a storage unit 106, a communication unit 107, and the like. The photoelectric conversion element 102 functions as an image capturing unit.

The image-forming optical system 101 can form an image (optical image) of a subject on the photoelectric conversion element 102 and has an exit pupil at a position at a predetermined distance from the photoelectric conversion element 102.

The photoelectric conversion element 102 is, for example, a semiconductor image sensor element such as a Complementary Metal Oxide Semiconductor (CMOS) sensor. The photoelectric conversion element 102 includes, for example, a pixel region in which pixels having a photoelectric conversion function are arranged in a two-dimensional manner.

The photoelectric conversion element 102 of the present embodiment employs, as a stereo camera system, an imaging element of an image-capturing-surface phase-difference distance-measuring scheme. That is, each pixel region includes one micro lens and two photoelectric conversion portions, and a subject image having parallax and formed on the photoelectric conversion element 102 is photoelectrically converted by the respective portions to generate a first image signal and a second image signal.

It should be noted that, although in the present embodiment, the photoelectric conversion element 102 of the image-capturing surface phase-difference scheme includes one micro lens and two photoelectric conversion portions per pixel region, the present disclosure is not limited thereto, and a configuration that includes at least two photoelectric conversion portions per pixel region is sufficient. For example, the image-capturing-surface phase-difference scheme may be realized with a quad-pixel structure having one micro lens and four photoelectric conversion portions.

Thus, the photoelectric conversion element 102 that serves as the image capturing unit generates at least a first image signal and a second image signal having a predetermined parallax. It should be noted, however, that the stereo camera system is not limited thereto, and, for example, a stereo camera configured by two cameras having parallax may be used.

The image processing unit 103 performs image processing such as black-level correction, gamma curve adjustment, noise reduction, digital gain adjustment, demosaicing, data compression, and the like on the image signals generated by the photoelectric conversion element 102 to generate a final image signal. An output of the image processing unit 103 is supplied to the distance measurement unit 104, an electric control unit (ECU) 301 of the moving object 300, and the camera control unit 105.

The distance measurement unit 104 performs recognition processing of objects such as surrounding people and vehicles by performing image recognition based on the first image signal and the second image signal supplied from the image processing unit 103. The distance measurement unit 104 also calculates a distance to an object based on a phase shift of images corresponding to parallax between the first image signal and the second image signal supplied from the image processing unit 103. That is, the distance measurement unit 104 calculates a distance value to a subject and a reliability of the distance value based on at least the first image signal and the second image signal.

The camera control unit 105 incorporates a CPU serving as a computer and a memory storing a computer program, and performs control of respective units of the camera 100 by the CPU executing the computer program stored in the memory.

It should be noted that the camera control unit 105 functions as a control unit and performs control of the length of an exposure period (electric charge accumulation time) for each frame and timing control of control signals by transmitting a reference signal that is repeatedly output to the camera 100 at predetermined intervals

It should be noted that, in the following explanation, “exposure” means operations from a start to an end of electric charge accumulation, photoelectric conversion, or image capturing in the photoelectric conversion element 102. It should be noted that in the present embodiment, the terms “electric charge accumulation,” “photoelectric conversion,” and “image capturing” are used with the same meaning, and the operations of electric charge accumulation, photoelectric conversion, and image capturing include, for example, in a case in which the photoelectric conversion element 102 is an APD, an operation of counting a photoelectrically converted signal by a counter circuit 211.

Additionally, the camera control unit 105 sets predetermined values for a light emission control unit 202 via the communication unit 107 and a communication unit 203, so that a pulse signal is output to a light emission unit 201 at predetermined timings synchronized with the reference signal, whereby a light emission period of the light emitter 200 is controlled.

Thus, a reference signal synchronized with the reference signal transmitted to the photoelectric conversion element 102 is also transmitted to the light emitter 200, and the light emitter 200 executes emission control in synchronization with the reference signal. Thereby, synchronization between an exposure timing of the photoelectric conversion element 102 and a light emission timing of the light emitter 200 becomes possible.

Here, the camera control unit 105 functions as a control unit that controls the light emission time of the emission unit and an exposure (electric charge accumulation) time of the image capturing unit such that the image capturing unit exposes (accumulates electric charge with respect to) reflected light of pulsed light in a predetermined distance range.

The storage unit 106 includes, for example, a recording medium such as a memory card or a hard disk and can store and read out image signals. The communication unit 107 includes wireless and wired interfaces, outputs generated image signals to outside the camera 100 and receives various signals from outside.

Additionally, in the present embodiment, the communication unit 107 is connected to the communication unit 203 of the light emitter 200 and also serves to transmit the above-described reference signal and control commands from the camera control unit 105 to the light emitter 200.

The light emitter 200 includes a light emission unit 201 that emits pulsed light, a light emission control unit 202, and a communication unit 203. The light emission unit 201 is, for example, a near-infrared LED that is disposed in front of the moving object 300 and that is configured as a combination of the near-infrared LED and a lens.

A wavelength of the pulsed light emitted by the light emission unit 201 is not limited to near-infrared and, for example, may be in the visible light region. Additionally, for example, the light emission unit 201 may be configured, as an emitter provided in the moving object 300, to change the luminous intensity of a headlight. It should be noted that the light emission unit 201 outputs pulsed light for a predetermined light emission time according to a pulse signal output from the light emission control unit 202.

The light emission control unit 202 receives, via the communication unit 203, a reference signal transmitted by the camera control unit 105 of the camera 100, and, based on the reference signal, generates a pulse signal at predetermined timings and outputs the pulse signal to the light emission unit 201.

Here, the light emission control unit 202 can set a period from reception of the reference signal to output of a pulse, a pulse-output width, a pulse non-output width, and a repetition cycle and repetition count from one pulse output to a subsequent pulse output.

By the camera control unit 105 setting predetermined values for the light emission control unit 202 via the communication unit 107 and the communication unit 203, a pulse signal is output to the light emission unit 201 at predetermined timings based on the reference signal, and a light emission period of the light emitter 200 is controlled. Thus, the light emission control unit 202 is controlled for light emission based on a signal that is identical to a reference signal that is input to the camera 100, the signal serving as a reference.

The communication unit 203 communicates with the communication unit 107 of the camera 100, receives setting information and the reference signal from the camera control unit 105 for the light emission control unit 202, and transmits the setting information and the reference signal to the light emission control unit 202.

The ECU 301 incorporates a CPU serving as a computer and a memory storing a computer program and controls respective portions of a vehicle control unit 302 by causing the CPU to execute the computer program stored in the memory.

An output of the distance measurement unit 104 is supplied to the camera control unit 105 and is also supplied to the vehicle control unit 302 and a display unit 303 via the ECU 301. The vehicle control unit 302 functions as a movement control unit that performs driving, stopping, direction control, and the like of the vehicle serving as the moving object, based on an output of the ECU 301. Additionally, the display unit 303 functions as a display unit and includes, for example, a display element such as a liquid-crystal device or an organic EL device, and is mounted on the moving object 300.

In the present embodiment, the ECU 301 can execute vehicle stop control (for example, automatic braking) according to contents of a distance measurement result, by receiving information of the distance measurement result from the distance measurement unit 104. The ECU 301 also receives distance measurement processing data from the distance measurement unit 104 and transmits the data to the display unit 303.

Based on an output from the ECU 301, the display unit 303 displays various information to a driver of the moving object 300 by using, for example, a GUI, such as images generated by the photoelectric conversion element 102, distance-measurement results obtained by the distance measurement unit 104, and a travel state of the vehicle.

It should be noted that the image processing unit 103, the distance measurement unit 104, and the like in FIG. 1 need not be mounted on the moving object 300, and may be provided in an external terminal and the like that is provided separately from the moving object 300, for remotely controlling the moving object 300 or for monitoring travelling of the moving object.

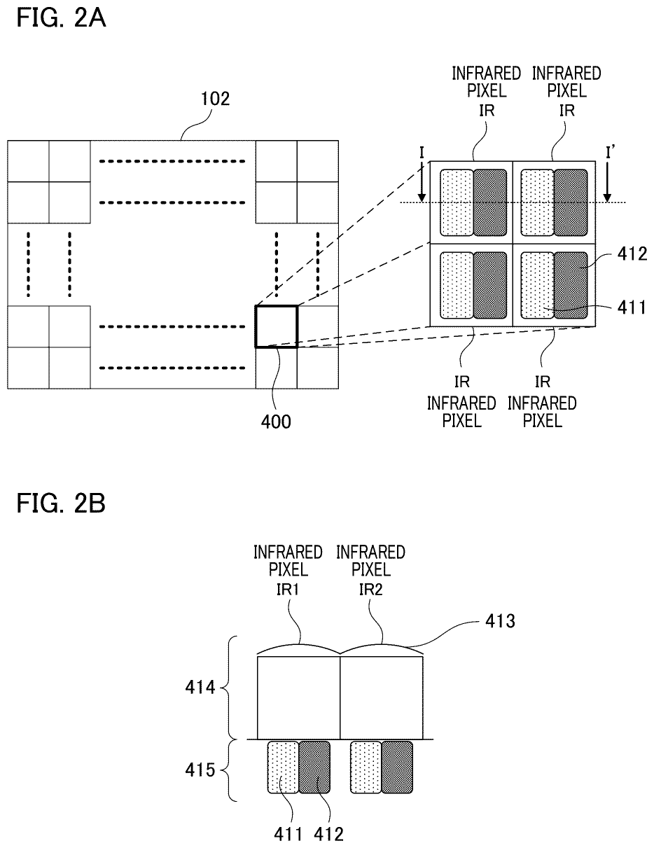

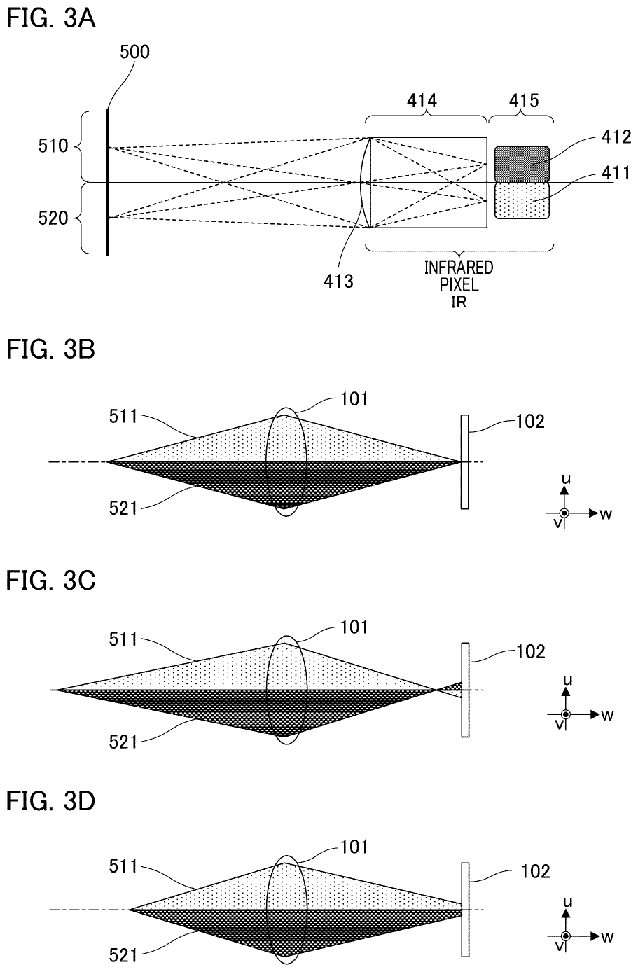

Here, with reference to FIG. 2 and FIG. 3, a distance measurement principle by the image-capturing-surface phase-difference scheme using the photoelectric conversion element 102 will be explained. FIG. 2A is a top view of the photoelectric conversion element 102 as viewed from a light-incident direction, and FIG. 2B is a cross-sectional view taken along line I-I′ of FIG. 2A.

As shown in FIG. 2A, the photoelectric conversion element 102 is configured by arranging, in a matrix, a plurality of pixel groups 400 of 2 rows×2 columns. The pixel group 400 has four infrared pixels IR that detect IR light. Additionally, each pixel has a first photoelectric conversion portion 411 and a second photoelectric conversion portion 412. Note that the arrangement of pixels in the pixel group 400 is not limited thereto and may be changed according to a wavelength bandwidth of light emitted from the light emitter 200.

That is, the pixel group 400 may include, for example, an infrared pixel IR that detects IR light, a red pixel that detects red light, a green pixel that detects green light, and a blue pixel that detects blue light. The pixel group 400 may also have two green pixels that detect green light, a red pixel that detects red light, and a blue pixel that detects blue light. In the above pixel arrangement, the two green pixels are arranged diagonally.

As described above, FIG. 2B is a cross-sectional view taken along line I-I′ of the pixel group 400 in FIG. 2A. Each pixel is configured by a light-guiding layer 414 including a micro lens 413 and a light receiving layer 415.

The light guiding layer 414 is composed of a light guiding member including a micro lens 413 for efficiently guiding light incident on pixels to the light receiving layer 415, a color filter that transmits light of a wavelength band to be detected by each pixel, and wirings for pixel readout and pixel driving. The light receiving layer 415 photoelectrically converts light incident via the light guiding layer 414 and outputs the light as an electric signal. The light receiving layer 415 has the first photoelectric conversion portion 411 and the second photoelectric conversion portion 412.

FIG. 3A to FIG. 3D are diagrams for explaining the relation between a distance to a subject and incident light in the image-capturing-surface phase-difference scheme. FIG. 3A is a schematic diagram illustrating an exit pupil 500 of the image-forming optical system 101 and light entering the first photoelectric conversion portion 411 and the second photoelectric conversion portion 412 of the infrared pixel IR of the photoelectric conversion element 102. Although the photoelectric conversion element 102 includes a plurality of pixels, explanation is simplified to one infrared pixel IR.

The micro lens 413 of the infrared pixel IR is disposed so that the exit pupil 500 and the light-receiving layer 415 are optically conjugated. As a result, light that has passed through a first pupil region 510, the first pupil region 510 being a partial pupil region included in the exit pupil 500, enters the first photoelectric conversion portion 411, and light that has passed through a second pupil region 520 enters the second photoelectric conversion portion 412.

The first photoelectric conversion portion 411 of each pixel photoelectrically converts received light and outputs a signal. From signals output from the plurality of first photoelectric conversion portions 411 included in the photoelectric conversion element 102, a first image signal is generated. The first image signal indicates an intensity distribution of a first image formed on the photoelectric conversion element 102 by light mainly having passed through the first pupil region 510.

The second photoelectric conversion portion 412 of each pixel photoelectrically converts received light and outputs a signal. From signals output from the plurality of second photoelectric conversion portions 412 included in the photoelectric conversion element 102, a second image signal is generated. The second image signal indicates an intensity distribution of a second image formed on the photoelectric conversion element 102 by light mainly having passed through the second pupil region 520.

A relative positional shift amount (hereinafter, referred to as a “parallax amount”) between the first image signal and the second image signal becomes an amount corresponding to a defocus amount. The relation between the parallax amount and the defocus amount will be explained with reference to FIG. 3B to FIG. 3D.

FIG. 3B, FIG. 3C, and FIG. 3D are schematic views illustrating the photoelectric conversion element 102 and the image-forming optical system 101. In the drawings, reference numeral 511 indicates first light passing through the first pupil region 510, and reference numeral 521 indicates second light passing through the second pupil region 520.

FIG. 3B shows an in-focus state, and in this state the first light 511 and the second light 521 converge on the image-forming optical system 101. At this time, the parallax amount between the first image signal formed by the first light 511 and the second image signal formed by the second light 521 is 0.

FIG. 3C shows a state in which defocus is in a negative direction of the w-axis on the image side. At this time, the parallax amount between the first image signal formed by the first light 511 and the second image signal formed by the second light 521 is not 0 and has a negative value.

FIG. 3D shows a state in which defocus is in a positive direction of the w-axis on the image side. At this time, the parallax amount between the first image signal formed by the first light 511 and the second image signal formed by the second light 521 is not 0 and has a positive value.

From comparison of FIG. 3C and FIG. 3D, it can be understood that the direction in which parallax occurs is interchanged according to whether the defocus amount is positive or negative. Additionally, from geometric relations, it can be understood that a parallax amount corresponding to the defocus amount is generated.

Accordingly, the parallax amount between the first image signal and the second image signal can be detected by a region-based matching method, such as a block-matching method, and can be converted into a defocus amount. In this context, the block-matching method is a method in which, for a selected region of one image, a region having high similarity (hereinafter referred to as a “parallax matching region”) is matched from the other image, and a positional shift between the selected region and the region having high similarity is taken as parallax.

Furthermore, by using an image-forming formula of the image-forming optical system 101, the defocus amount on the image side can be converted into an object distance. The image-forming formula of the image-forming optical system 101 is represented by the following Formula (1), and in the formula a focal length of the photoelectric conversion element 102 is denoted by f, a distance from an image-side principal point to the photoelectric conversion element 102 is Ipp, a defocus amount is ΔL, and a distance to the object is D.

$$D = \frac{1}{\{ \frac{1}{f} - 1 / ( Ipp + Δ L ) \}} \qquad ( Formula ( 1 ) )$$

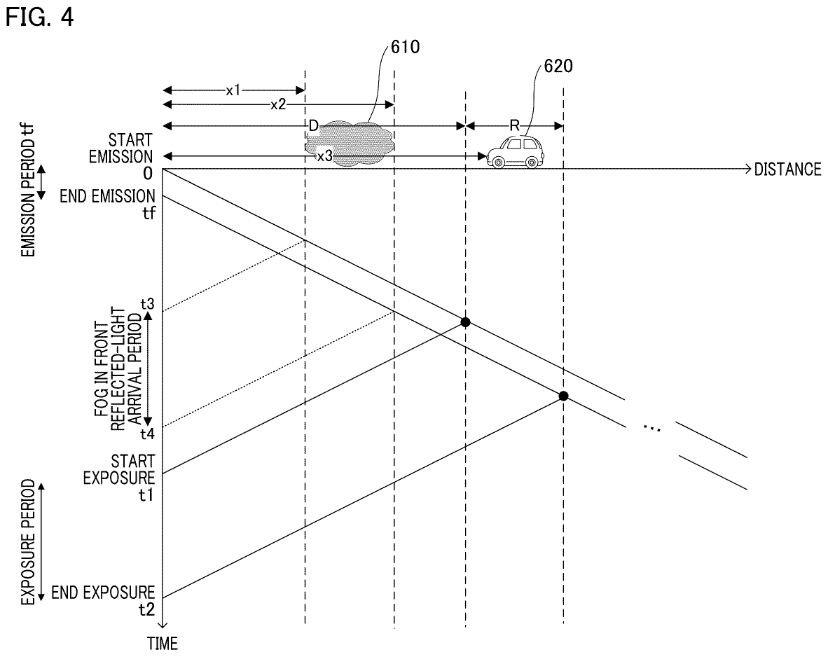

Next, FIG. 4 is a diagram illustrating an example of a relation between travel of reflected light and exposure timing in range-gating control and shows a relation among emission from the light emitter 200, travel of reflected light thereof, and exposure timing of the camera 100. Note that, in FIG. 4, a horizontal axis indicates distance, and a vertical axis indicates time.

FIG. 4 illustrates a method for acquiring an image (range-gated image) obtained by imaging a target distance by performing control (range-gating control) in which light emission timing and exposure timing are synchronized according to the target distance. Additionally, a camera that acquires an image of a target distance range by such range-gating control is referred to as a range-gated camera.

First, the horizontal axis will be explained. Fog 610 exists between a distance x1 and a distance x2, and a vehicle 620 exists at a distance x3. Additionally, in FIG. 4, a range-gated image is acquired by taking, as a starting point, a position of the camera 100 and in a predetermined distance range therefrom by range-gating control.

In this case, a target distance range R becomes a target distance range to be imaged. At this time, the vehicle 620 exists within the target distance range R. Additionally, a subject image within the target distance range R is photoelectrically converted by the photoelectric conversion element 102 and held as electric charge in each pixel.

Next, the vertical axis will be explained. Time 0 is an emission start timing at the light emitter 200, and time tf is an emission end timing. At this time, a light emission period is tf. Additionally, in the case of acquiring a range-gated image within the target distance range R by taking the position of the camera 100 as a starting point, an exposure start time (electric charge accumulation start time) is defined as time t1, and an exposure end time (electric charge accumulation end time) is defined as time t2.

Time t1 is a timing at which light emitted from the light emitter 200 at time 0 returns to the camera 100 as reflected light from the vehicle 620. Time t2 is a timing at which light emitted from the light emitter 200 returns to the camera 100 as reflected light from a location that is advanced from distance D by an amount equal to the target distance range R.

Furthermore, the timing at which the first reflected light returns to the camera 100 is defined as time t3, and the timing at which the last reflected light due to the fog 610 returns to the camera 100 is defined as time t4.

In range-gating control, an exposure (electric charge accumulation) is not performed during a period from a time t3 to a time t4 in which reflected light from the fog 610 reaches the camera 100, and the exposure (electric charge accumulation) is performed only during a period from a time t1 to a time t2 in which reflected light from the target distance range starting at distance D arrives. Accordingly, the image of the vehicle 620 can be clearly acquired while removing the fog 610.

Here, an explanation will be given regarding the time until reflected light from a target object located at a distance x returns to the camera 100. Emitted light that begins to be emitted at time 0 strikes a target object located at a distance x, and a timing at which the reflected light returns to the image capturing unit is defined as time tr.

At this time, a relation between the return timing tr of the reflected light and the distance x to the imaging target object is given by the following Formula (2):

$$time tr = 2 x / speed of light c ( about 3 \times 10 \hat{} 8 m / s ) \qquad ( Formula ( 2 ) )$$

As shown in FIG. 4, when the target distance range R from the distance D is set as an imaging range, an exposure (electric charge accumulation) timing t1 at a starting point of the target distance range R can be obtained as Formula (3) below by substituting the distance D for the distance x in the above Formula (2).

$$time t 1 = 2 D / speed of light c \qquad ( Formula ( 3 ) )$$

Additionally, an exposure (electric charge accumulation) timing t2 at an end point of the target distance range R can be obtained as Formula (4) below by substituting the distance D+R for the distance x in the above Formula (2) and adding the time tf.

$$t 2 = tf + 2 ( D + R ) / speed of light c \qquad Formula ( 4 )$$

Thus, by controlling a time tr from light emission to exposure (electric charge accumulation) according to a distance x (target distance) to be imaged, range-gating control is realized that makes it possible to clearly image a subject located at the target distance even when fog and the like is present between the camera and the target distance.

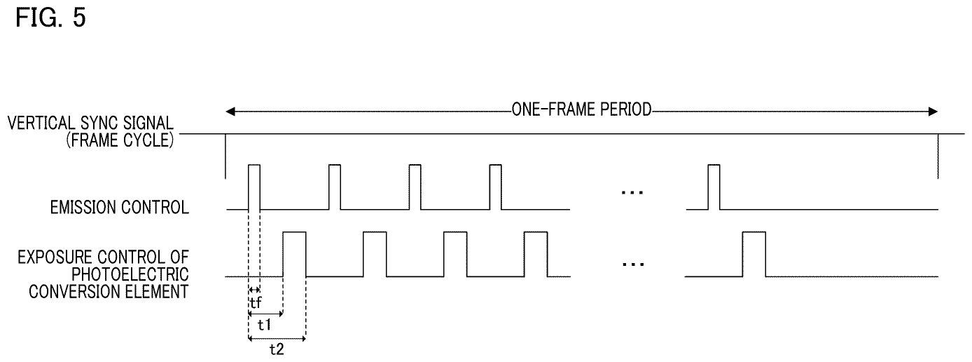

FIG. 5 is a diagram illustrating an example of light emission and exposure (electric charge accumulation) control operations during one frame period in range-gating control and illustrates control operations for obtaining a range-gated image for each frame time.

In FIG. 5, a vertical synchronization signal indicates a frame cycle of image capturing, and a period between a Low pulse and a next Low pulse is a one-frame time. “Emission control” indicates an emission timing of the light emission unit 201, and “exposure (electric charge accumulation) control of the photoelectric conversion element” indicates a length of an exposure (electric charge accumulation) period for each frame of the photoelectric conversion element 102 and a timing of a control signal output by the camera control unit 105.

In range-gating control, an emission period is controlled in a pulsed manner by the camera control unit 105, and exposure (electric charge accumulation) of the photoelectric conversion element 102 is performed only on reflected light from a specific target distance range R.

In this context, a light emission period from a start to an end of light emission is defined as tf, a time from the start of light emission to a start of exposure (electric charge accumulation) is defined as t1, and a time from the start of light emission to an end of exposure (electric charge accumulation) is defined as t2. In this case, t1 represents a period from the start of light emission until light reaches a specific target distance range R and reflected light returns to the camera 100, and a period from t1 to t2 corresponds to a period during which reflected light from the specific target distance range R is exposed.

In order to properly perform range-gating control, it is necessary to synchronize the timing of a light emission start, and an exposure start in accordance with a predetermined target distance range. In the present embodiment, synchronization is achieved by the camera control unit 105 transmitting the identical reference signal to the photoelectric conversion element 102 and the light emission control unit 202.

As shown in the light emission control of the timing chart in FIG. 5, a period from the start of one light emission to the start of the next light emission constitutes a range-gating operation cycle. Then, light received by the photoelectric conversion element 102 in one range-gating operation cycle is converted into electric charge and held in the photoelectric conversion element 102.

In this state, the next range-gating operation cycle is performed, and light newly received by the photoelectric conversion element 102 is converted into electric charge and added to the electric charge that has been held in the photoelectric conversion element 102. It is to be noted that an interval from one light emission to the next light emission is set based on time until reflected light sufficiently attenuates and no longer returns to the camera 100.

As shown in FIG. 5, within one frame period, range-gating operation cycles are performed a predetermined number of times as set, and electric charge that has been finally added and held within the one frame period is transferred to a memory in the photoelectric conversion element 102, and after the transfer, the added and held electric charge is reset.

Thus, in the present embodiment, since an exposure (electric charge accumulation) period is synchronized with light emission by the light emitter 200, it is possible to obtain a clear image of a desired distance range even under adverse weather conditions such as fog. On the other hand, in range-gating control, distance measurement can be performed only in units of a target distance range R that depends on the exposure time of the camera 100 and a light emission time of the light emitter 200.

In order to improve distance measurement accuracy, reduction of the target distance range R is necessary, and one conceivable method is shortening an exposure time of the camera 100 and a light emission time of the light emitter 200, although such shortening is difficult due to physical control limits of the camera 100 and the light emitter 200.

Additionally, in a case in which range-gated imaging is to be performed to a far distance while the target distance range R is small, the number of exposures of the camera 100 increases, resulting in a drawback that power consumption becomes large and also in a drawback that time is required until distance measurement can be performed to the far distance.

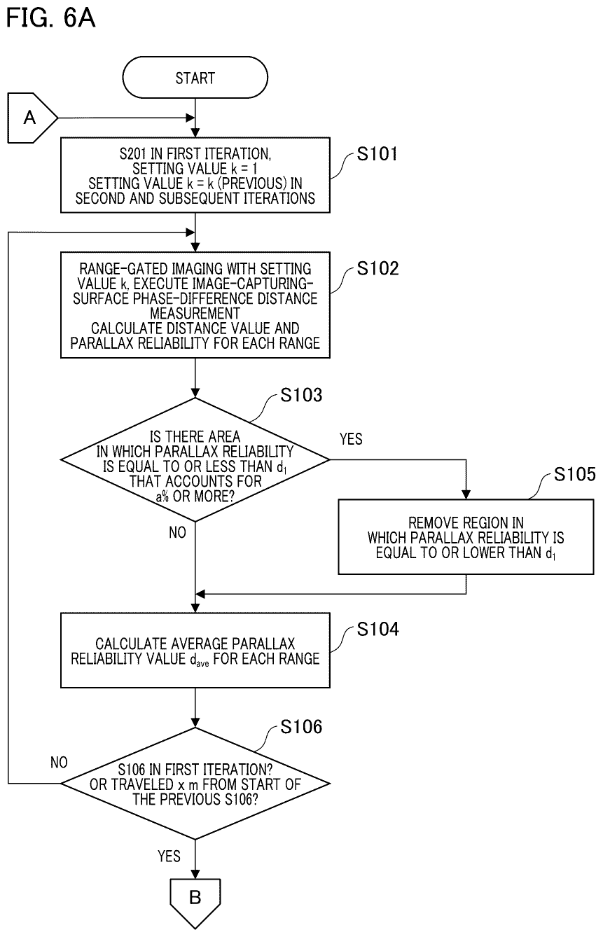

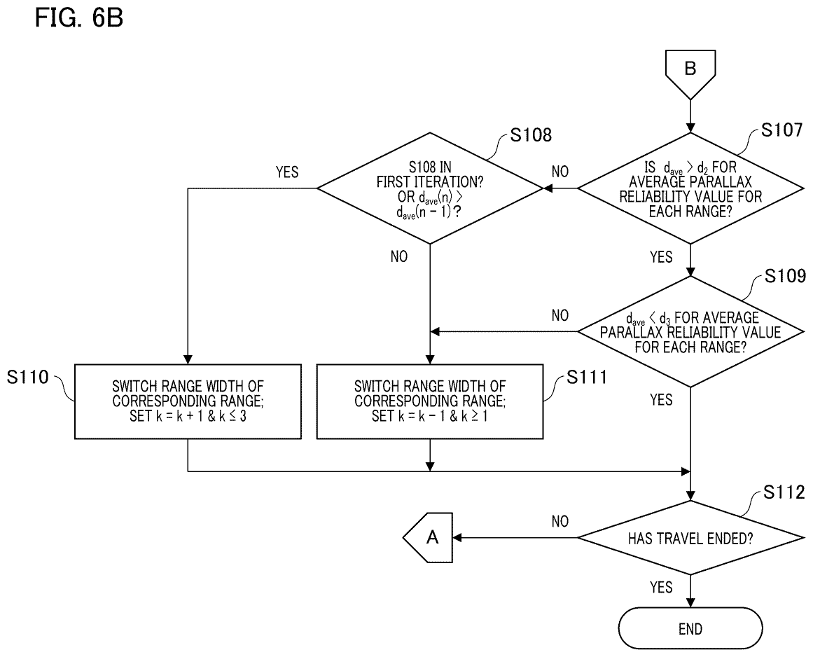

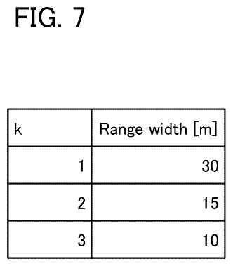

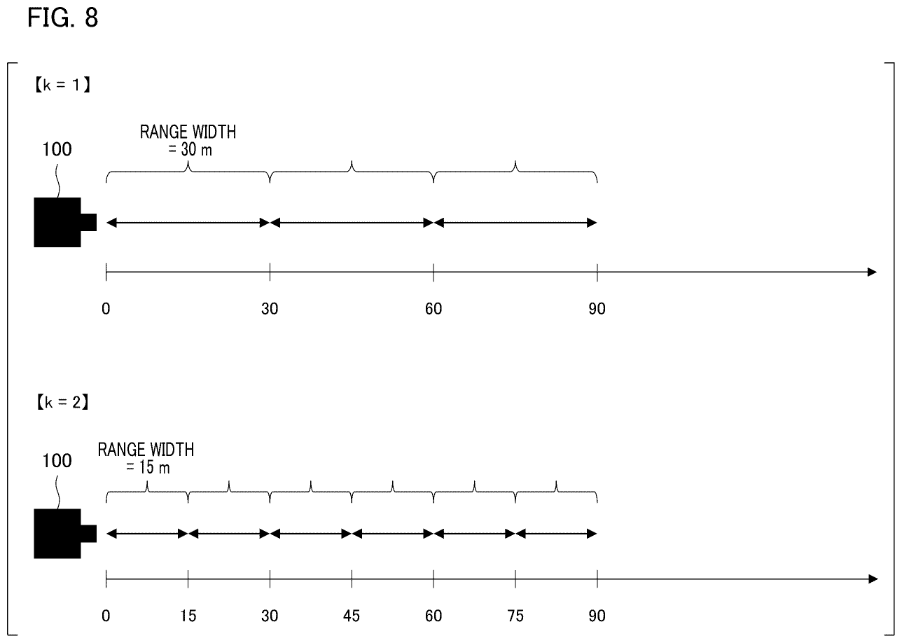

Next, stereo range-gated camera distance-measurement processing in the present embodiment will be explained with reference to FIG. 6A, FIG. 6B, FIG. 7, and FIG. 8.

FIG. 6A is a flowchart illustrating an example of processing in the control method according to the first embodiment, and FIG. 6B is a flowchart illustrating an example of processing after FIG. 6A. Control of a light-emitting unit that emits pulsed light and an image capturing unit that generates a first image signal and a second image signal having a predetermined parallax is performed in accordance with the flowcharts of FIG. 6A and FIG. 6B.

Operations of respective steps of the flowcharts of FIG. 6A and FIG. 6B are sequentially performed by a CPU and the like serving as a computer in the camera control unit 105, by executing a computer program stored in a memory.

It should be noted that, for convenience of explanation, explanation will be given separately for processing in and after step S101 in a first iteration and for processing in and after step S101 in an n-th (n≥2) iteration.

First, processing in and after step S101 in a first iteration will be explained. In step S101, the camera control unit 105 defines a setting value k for performing range-gating control of the light emitter 200, the first photoelectric conversion portion 411, and the second photoelectric conversion portion 412.

A setting value k is a value corresponding to a range width of distance in the processing flow of FIG. 6A and FIG. 6B, and the range width is determined by a light emission time of the light emitter 200 and by exposure (electric charge accumulation) times and exposure (electric charge accumulation) timings of the first photoelectric conversion portion 411 and a second photoelectric conversion portion 412.

FIG. 7 is a diagram illustrating an example of a relation between the setting value k and the range width according to the first embodiment, showing, in this processing, the setting value k and a range width corresponding to the setting value k, although the present disclosure is not limited thereto. In FIG. 7, k is defined only as 1, 2, and 3, and here the setting value k is defined as k=1 (range width: 30 m).

In step S102, range-gated imaging is performed based on the setting value k, and image-capturing-surface phase-difference distance measurement is performed. The distance value and parallax reliability are calculated for each range. That is, in step S102, the camera control unit 105 performs range-gating control on the light emitter 200 and the first photoelectric conversion portion 411 and the second photoelectric conversion portion 412 so that the setting value k=1 (range width: 30 m) is achieved, and acquires a first image signal and a second image signal for each distance range.

Here, step S102 functions as a distance measurement step (distance measurement unit) that calculates a distance value to a subject and a reliability of the distance value based on the first image signal and the second image signal.

Thereafter, the distance measurement unit 104 performs image-capturing-surface phase-difference distance measurement based on the first image signal and the second image signal in each distance range and calculates a distance value for each distance range. A distance value is obtained, for example, by calculating a parallax amount for each pixel based on the first image signal and the second image signal using the above-described block matching method and converting the parallax amount into a distance value.

The distance measurement unit 104 further calculates a variation in luminance value for each parallax matching region in the block-matching method. The variation in luminance value serves as an index indicating the accuracy of a calculated parallax amount and is hereinafter referred to as “parallax reliability.”

The parallax reliability can be evaluated, for example, by a ratio of a standard deviation to an average value of luminance values in a parallax matching region. In a case in which a change in pixel values (so-called contrast) within the matching region is large, the standard deviation becomes large.

Additionally, in a case in which the amount of light incident on pixels is large, an average value becomes large. In a case in which the amount of light incident on pixels is large, photon shot noise is large. That is, the average value has a positive correlation with the amount of noise. A ratio of an average value to a standard deviation (standard deviation/average value) corresponds to a ratio between a magnitude of contrast and an amount of noise.

In a case in which contrast is sufficiently large relative to noise, it can be estimated that an error in calculating a parallax amount is small. That is, as parallax reliability increases, the error in the calculated parallax amount decreases, and the parallax amount may be regarded as being more accurate. In a case in which the number of pixels included in the matching region is n, the luminance values of the respective pixels are x1, x2 through xn, and an average luminance value is x, the parallax reliability d can be obtained, for example, by the following Formula (5).

$$\begin{matrix}PARALLAX \\ RELIABILITY\end{matrix} d = \frac{\sqrt{\frac{1}{n} {\sum }_{i = 1}^{n} {( {x}_{i} - \overline{x} )}^{2}}}{\overline{x}} \qquad ( Formula ( 5 ) )$$

Thus, in the present embodiment, reliability is calculated based on variation in luminance values or based on both variation in luminance values and an average luminance value, in a pixel group having at least the first image signal and the second image signal.

In step S103, the distance measurement unit 104 determines whether or not a ratio of parallax matching regions in which a calculated parallax reliability is equal to or less than a threshold d1 is equal to or greater than a % (for example, whether or not parallax matching regions having a parallax reliability equal to or less than the threshold d1 account for 50% or more of all parallax matching regions).

That is, in a range-gated image for each distance range, determination is made as to whether or not a region having low parallax reliability, such as a road surface, exists in a proportion equal to or greater than a predetermined ratio. In this context, the threshold d1 indicates parallax reliability on a road surface.

In a case in which, in step S103, it is determined that the ratio of parallax matching regions having a parallax reliability equal to or less than the threshold d1 is less than a %, the process proceeds to step S104. In step S104, a parallax-reliability average value dₐᵥₑ is calculated for each range. That is, the distance-measurement unit 104 calculates, for each distance range, a parallax-reliability average value dₐᵥₑ based on the parallax reliability in each parallax matching region calculated for each distance range.

In contrast, in a case in which it is determined in step S103 that the ratio of parallax matching regions having a parallax reliability equal to or less than the threshold d1 is equal to or greater than a %, the process proceeds to step S105. In step S105, regions having parallax reliability equal to or less than the threshold d1 are removed. That is, the distance measurement unit 104 removes image signals in parallax matching regions having a parallax reliability equal to or less than the threshold d1 from the first image signal and the second image signal of each distance range.

That is, in the present embodiment, without using the first image signal and the second image signal having reliability equal to or less than a predetermined value, the size of a distance range of the first image signal and the second image signal generated by the image-capturing unit is changed based on the first image signal and the second image signal having reliability greater than the predetermined value.

Subsequently, the process proceeds to step S104, and a parallax-reliability average value dₐᵥₑ is calculated for each range. That is, a parallax-reliability average value dₐᵥₑ for each distance range is calculated based on the first image signal and the second image signal in the remaining parallax matching regions after removal in step S105.

Thus, step S105 prevents the influence of a road surface having low parallax reliability when calculating a parallax-reliability average value dₐᵥₑ from the parallax reliability of all parallax matching regions, for example, in a case in which a range-gated image includes both a subject and a road surface. That is, in such a case, the process prevents the parallax reliability of a distance range in which a subject is captured from being calculated as low due to the influence of a road surface and the like.

In step S106, it is determined whether or not the process is that of step S106 in a first iteration, or whether or not the moving object has traveled x meters from the start of a previous step S106. Here, since it is determined that step S106 is in a first iteration, the process proceeds to step S107 in FIG. 6B. In step S107, the distance-measurement unit 104 compares a parallax-reliability average value dₐᵥₑ for each distance range (range) with a threshold d2 and determines whether or not the average parallax reliability satisfies dₐᵥₑ>threshold d2.

The threshold d2 is a minimum parallax-reliability average value required to determine that the distance value of a subject calculated in the present embodiment is an accurate value. In a case in which “NO” is determined in step S107, that is, in a case in which it is determined that there exists a distance range in which the parallax-reliability average value dₐᵥₑ is equal to or less than the threshold d2, the process proceeds to step S108.

In a case in which “YES” is determined in step S107, that is, in a case in which it is determined that the parallax-reliability average value dₐᵥₑ in all distance ranges is greater than the threshold d2, the process proceeds to step S109.

In step S108, it is determined whether the process is step S108 in a first iteration or whether dₐᵥₑ (n)>dₐᵥₑ (n−1). Here, since the process in step S108 is in a first iteration, the process proceeds from step S108 to step S110, the process proceeds from step S108 to step S110.

In step S110, the range width of a corresponding range is switched, and the setting value is set to k=k+1 (where k≤3). That is, the distance measurement unit 104 updates k to k+1 (where k≤3) only for a range (distance range) determined to satisfy a parallax-reliability average value dₐᵥₑ≤threshold d2 for each distance range, and, as shown in FIG. 8, the setting value k is changed from 1 to 2.

FIG. 8 is a diagram illustrating an example of division of a range width according to the first embodiment. That is, in a case in which k=1, a range (distance range) width is 30 m, whereas in a case in which k=2, each range (distance range) is divided into two, and the range width (distance range) is 15 m.

When range-gated imaging is performed with a range width of 15 m, which is a range width after division, it becomes possible to obtain a range-gated image in which stray light, such as diffused reflection from fog, is reduced and image quality of the subject is improved, as compared to range-gated imaging with a range width before division. Additionally, since image-capturing-surface phase-difference distance measurement can be performed based on the range-gated image having improved image quality, the calculated parallax reliability also improves.

Thus, in step S110 of the present embodiment, in a case in which the reliability is equal to or less than a predetermined threshold d2, a light emission time of the light emitting unit and an exposure time of the image capturing unit are controlled so that the distance range is reduced.

In step S112, the camera control unit 105 determines whether or not an operation for terminating travel of the moving object 300 has been performed, for example, by a driver of the moving object. In a case in which it is determined that an operation for terminating travel has been performed, the stereo range-gated camera distance measurement processing flow shown in FIG. 6A and FIG. 6B ends. In a case in which it is determined that an operation for terminating travel has not been performed, the process proceeds to step S101, and a second stereo range-gated camera distance measurement process is started.

On the other hand, in a case in which “YES” is determined in step S107, it is determined in step S109 whether or not the parallax-reliability average value dₐᵥₑ for each range satisfies dₐᵥₑ<threshold d3. That is, in step S109, the distance measurement unit 104 compares the parallax-reliability average value dₐᵥₑ for each range calculated by the distance measurement unit 104 with the threshold d3 and determines whether or not there exists a distance range in which the parallax-reliability average value dₐᵥₑ is smaller than the threshold d3.

In a case in which “NO” is determined in step S109, that is, in a case in which a distance range in which the parallax-reliability average value dₐᵥₑ is greater than the threshold d3 is present, the process proceeds to step S111.

In contrast, in a case in which “YES” is determined in step S109, that is, in a case in which the parallax-reliability average value dₐᵥₑ of each distance range is less than the threshold d3, the process proceeds to step S112. It should be noted that the threshold d3 is a parallax-reliability average value that is sufficient when determining that the distance value of a subject calculated in the present embodiment is an accurate value.

It should be noted that, in a case in which an attempt is made for the parallax-reliability average value to become greater than the threshold d3, it is necessary to further divide the range width, and the time until completion of imaging of a desired distance range consequently becomes longer, and therefore, prolongation of the imaging time is prevented by step S111 to be described below. Here, the thresholds d1, d2, and d3 have a relation represented by Formula (6) below.

$$d 1 < d 2 < d 3 \qquad ( Formula ( 6 ) )$$

In step S111, a range width of a corresponding range is switched and the setting value is set to k=k−1 (where k≥1). That is, the distance measurement unit 104 updates k to k−1 for only the distance range in which the parallax-reliability average value dₐᵥₑ is determined to satisfy dₐᵥₑ>threshold d3 (where k≥1). That is, in this case, as shown in FIG. 8, the setting value k is kept at k=1 (range width of 30 m).

Thus, in step S111 of the present embodiment, based on the reliability, the control unit controls the emission unit and the image capturing unit such that a distance range of an image photographed by one exposure of the image capturing unit becomes larger.

Here, steps S110 and S111 function as control steps (control unit) in which a light emission time of the emission unit and an exposure time of the image capturing unit are controlled such that the image capturing unit is exposed to reflected light of pulsed light within a predetermined distance range. Additionally, in the control step (the control unit), based on the reliability, a light emission time of the emission unit and an exposure time of the image capturing unit are controlled such that a size of a distance range of at least the first image signal and the second image signal that are generated by the image capturing unit is changed.

In step S112, as described above, the camera control unit 105 determines whether or not an operation for terminating travel of the moving object 300 has been performed. In a case in which an operation for terminating travel has been performed, the stereo range-gated camera distance measurement processing shown in FIG. 6A and FIG. 6B ends. In a case in which it is determined that an operation for terminating travel has not been performed, the process proceeds to step S101, and a second stereo range-gated camera distance measurement process is started.

Next, processing in and after step S101 in an n-th iteration (n≥2) will be explained with reference to FIG. 6A, FIG. 6B, FIG. 7, and FIG. 8. Processing in step S101 is as described above. Here, since this is step S101 in an n-th iteration, the camera control unit 105 sets the setting value k to the value from step S112 of the (n−1)-th iteration.

In step S102, as described above, the camera control unit 105 performs range-gating control with the setting value k and acquires first and second image signals of each distance range. Additionally, based on the acquired first and second image signals of each distance range, the distance-measurement unit 104 performs image-capturing-surface phase-difference distance measurement and calculates the distance value of each distance range.

Steps S103, S104, and S105 are as described above, and, in a case in which there is a parallax matching region in which the parallax reliability is equal to or less than the threshold d1 in an amount of a % or more from the first and second image signals of each distance range, in step S105, the image signals are removed. Then, in step S104, a parallax-reliability average value dₐᵥₑ of each distance range is calculated.

In step S106, the camera control unit 105 determines whether or not the moving object has traveled x meters from a start of step S106 in the n−1-th iteration. In a case in which the moving object has traveled x meters from the start of step S106 in the n−1-th iteration, the process proceeds to step S107 of FIG. 6B, and, in a case in which the moving object has not traveled x meters, the process proceeds to step S101.

In step S107, as described above, the distance measurement unit 104 determines whether or not the parallax-reliability average value dₐᵥₑ>threshold d2. In a case in which it is determined that there is a range in which the parallax-reliability average value dₐᵥₑ is equal to or less than the threshold d2, the process proceeds to step S108.

Step S108 is processing executed by the distance measurement unit 104, and it is determined whether or not average parallax-reliability values dₐᵥₑ(n) of each distance range in the n-th iteration are greater than parallax-reliability average values dₐᵥₑ(n−1) of each distance range in the (n−1)-th iteration.

In a case in which average parallax reliability values dₐᵥₑ(n) of each distance range calculated in step S104 in the n-th iteration are greater than parallax-reliability average values dₐᵥₑ(n−1) of each distance range calculated in step S104 in the (n−1)-th iteration, the process proceeds to step S110.

In a case in which parallax-reliability average values dₐᵥₑ (n) of each distance range calculated in step S104 in the n-th iteration are equal to or less than parallax-reliability average values dₐᵥₑ (n−1) of each distance range calculated in step S104 in the (n−1)-th iteration, the process proceeds to step S111.

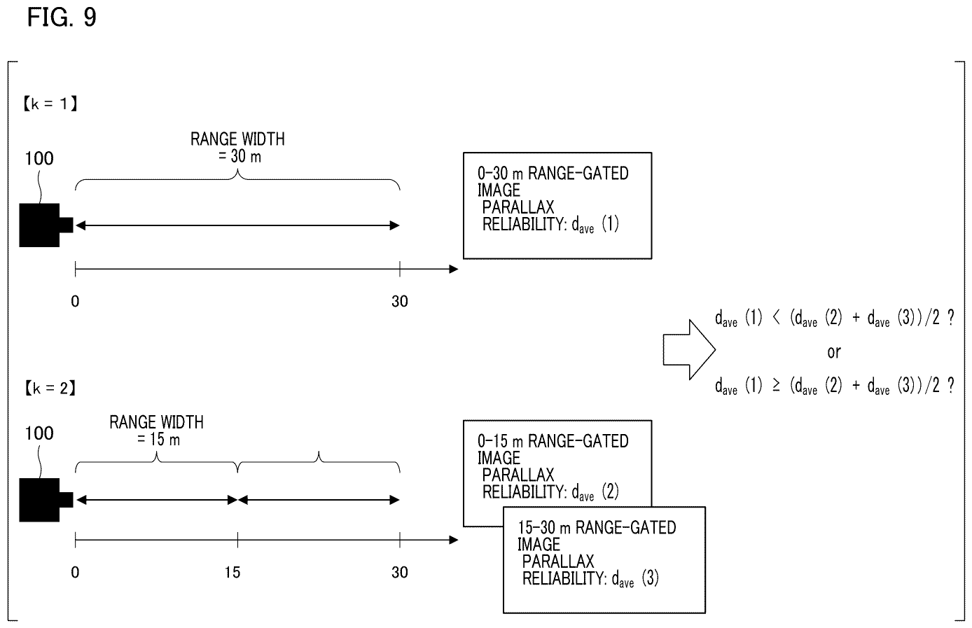

A method for comparing parallax-reliability average values dₐᵥₑ is shown in FIG. 9. FIG. 9 is a diagram illustrating an example of a method for comparing parallax reliability in each distance range acquired by range-gated imaging using different setting values k. In this context, a parallax-reliability average value of a range-gated image calculated in step S104 in a first iteration and at 30 m in front of the camera 100 is defined as dₐᵥₑ (1).

Additionally, a parallax-reliability average value of a range-gated image calculated in step S104 in a second iteration and at 15 m in front of the camera 100 is defined as dₐᵥₑ (2), and a parallax-reliability average value of a range-gated image at 15 m to 30 m that is calculated in step S104 in the second iteration is defined as dₐᵥₑ (3). Since comparison of parallax-reliability average values is performed in the identical range, a magnitude of dₐᵥₑ (1) is compared to a magnitude of (dₐᵥₑ (2)+dₐᵥₑ (3))/2.

I In a case in which (dₐᵥₑ (2)+dₐᵥₑ (3))/2 is larger than dₐᵥₑ (1), it is considered that influence by stray light is reduced and that the parallax-reliability average value is improved as a result of having divided the range width. Therefore, it can be predicted that the parallax-reliability average value can be further improved by further dividing the range width.

In contrast, in a case in which (dₐᵥₑ (2)+dₐᵥₑ (3))/2 is equal to or smaller than dₐᵥₑ (1), it is considered that the influence by stray light is small in that distance range, and that many subjects such as a road surface having a low parallax-reliability average value are included.

Therefore, the parallax-reliability average value is predicted to be unlikely to be improved even when the range width is divided. Accordingly, it is considered desirable to integrate the range width and shorten the time until completion of imaging of a desired distance range.

Step S110 is processing executed by the distance measurement unit 104, and, with respect to the parallax-reliability average values dₐᵥₑ for each distance range in the n−1-th iteration, only for the distance ranges in which the parallax-reliability average values dₐᵥₑ for each distance range in the n-th iteration are larger, a setting value k is updated to k+1. As a result, the range width is divided as shown in FIG. 8. In this case, k is set so as to satisfy k≤3.

Step S111 is processing executed by the distance-measurement unit 104, and, with respect to the parallax-reliability average values dₐᵥₑ for each distance range in the n−1-th iteration, only for the distance ranges in which the parallax-reliability average values dₐᵥₑ for each distance range in the n-th iteration are equal to or smaller, the setting value k is updated to k−1. As a result, the range width is integrated (where k≥1).

In step S112, the camera control unit 105 determines whether or not an operation for terminating travel of the moving object 300 has been performed. In a case in which an operation for terminating travel has been performed, the stereo range-gated camera distance measurement processing shown in FIG. 6A and FIG. 6B ends. In a case in which it is determined that the operation for terminating travel has not been performed, the process proceeds to step S101, and (n+1)-th stereo range-gated camera distance measurement processing is started.

In a case in which it is determined in step S107 that the parallax-reliability average values dₐᵥₑ for all distance ranges are larger than the threshold d2, the process proceeds to step S109.

In step S109, the distance measurement unit 104 compares parallax-reliability average values dₐᵥₑ for the respective distance ranges calculated by the distance measurement unit 104 with a threshold d3 and determines whether or not there is a distance range in which the parallax-reliability average values dₐᵥₑ<d3. In a case in which there is a distance range in which the parallax-reliability average value dₐᵥₑ is larger than the threshold d3, the process proceeds to step S111. In a case in which the parallax-reliability average values dₐᵥₑ for all the distance ranges are smaller than the threshold d3, the process proceeds to step S112.

In step S111, the distance-measurement unit 104 updates the setting value k to k−1 only for the distance ranges in which the parallax-reliability average value dₐᵥₑ of each distance range is greater than the threshold d3, and integrates the range width.

In step S112, as described above, the camera control unit 105 determines whether or not an operation for terminating travel of the moving object 300 has been performed. In a case in which an operation for terminating travel has been performed, the stereo range-gated camera distance measurement processing shown in FIG. 6A and FIG. 6B ends. In a case in which it is determined that the operation for terminating travel has not been performed, the process proceeds to step S101, and n+1-th stereo range-gated camera distance measurement processing is started.

Thus, in the present embodiment, by dividing or integrating the range width based on the parallax reliability calculated from the range-gated images, it is possible to maintain a parallax reliability equal to or higher than a predetermined value while suppressing an extension of time required for photographing an entire photographing range.

### Second Embodiment

Next, an explanation will be given of a second embodiment of the present disclosure. In the first embodiment, the stereo range-gated camera distance-measurement processing has been explained. In the second embodiment, a configuration and a processing flow are explained in which a visibility state around a vehicle is determined, and, in a case in which visibility is poor, stereo range-gated camera distance measurement is performed, and, in a case in which visibility is good, stereo camera distance measurement is performed.

FIG. 10 is a functional block diagram illustrating an example of a configuration of the camera 100, the light emitter 200, and the moving object 300 according to the second embodiment. The difference from the block diagram in the first embodiment illustrated in FIG. 1 is only that the camera 100 includes a visibility degradation determination unit 108, and explanation of the other configurations is omitted because the other configurations are similar to those of the first embodiment.

The visibility degradation determination unit 108 acquires and determines a visibility state around the vehicle, and outputs a determination result to the camera control unit 105. Note that the visibility degradation determination unit 108 functions as a visibility state determination unit that determines a visibility state around the image capturing unit.

Poor visibility refers, for example, to adverse weather such as rain or fog, or to dark places such as nighttime. The adverse weather may be determined by using, for example, a known technology such as a method described in Japanese Laid-Open Patent Publication No. 2008-33872.

In the method described in Japanese Laid-Open Patent Publication No. 2008-33872, a range irradiated by headlights of a moving object and a range not irradiated are imaged by a camera mounted on the moving object, and whether or not visibility is poor is determined based on a luminance difference therebetween. Additionally, whether or not the place is a dark place may be determined by using, for example, a light-receiving sensor mounted on the moving object and determining that the place is a dark place in a case in which an amount of light around the vehicle becomes equal to or smaller than a predetermined threshold.

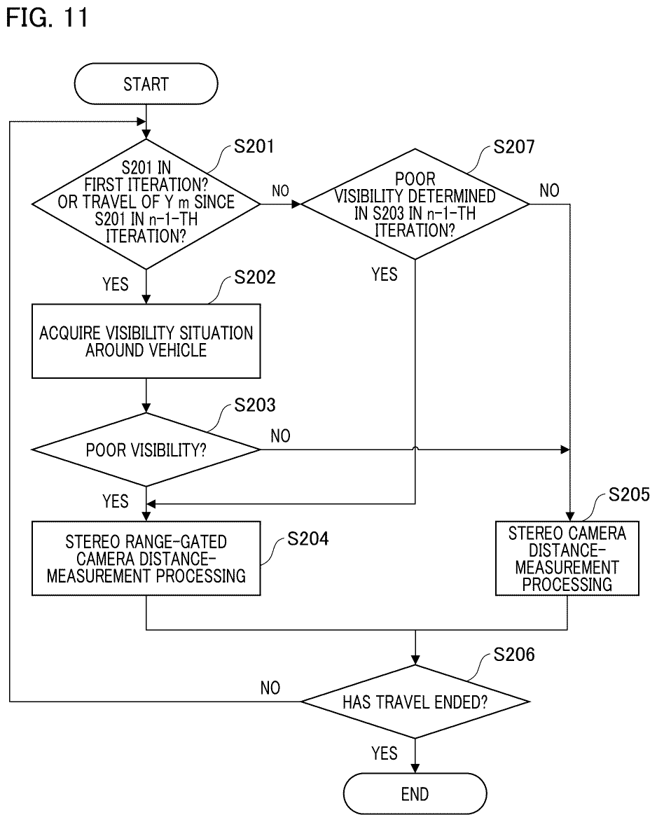

Next, FIG. 11 is a flowchart illustrating an example of processing according to the second embodiment. Note that operations of respective steps in the flowchart of FIG. 11 are sequentially executed by a CPU and the like serving as a computer in the camera control unit 105 executing a computer program stored in a memory.

Note that explanations are given separately for processing in and after step S201 in a first iteration and processing in and after step S201 in an n-th iteration (n≥2). First, processing in and after step S201 in the first iteration will be explained.

In step S201, it is determined whether the processing is step S201 in a first iteration or whether travel of Y m has been performed from step S201 in an (n−1)-th iteration. In a case in which the determination result is “YES”, the process proceeds to step S202, and in a case in which the determination result is “NO”, the process proceeds to step S207. Here, since the processing is step S201 in a first iteration, the process proceeds to step S202.

In step S202, the visibility degradation determination unit 108 acquires a visibility situation around the vehicle. As described above, the visibility situation is determined by a method described in Japanese Laid-Open Patent Publication No. 2008-33872 or by using a light-receiving sensor attached to the moving object.

In step S203, whether or not the vicinity of the vehicle is in poor visibility is determined based on the acquired visibility state. In a case in which poor visibility is determined, the process proceeds to step S204. In a case in which good visibility is determined, the process proceeds to step S205.

In step S204, stereo range-gated camera distance measurement explained in the first embodiment is performed. As described above, this distance-measurement method enables a distance to a subject within a distance range to be accurately calculated even in a case of poor visibility by performing exposure control synchronized with light emission. Additionally, a parallax reliability equal to or higher than a predetermined value can be maintained while suppressing an extension of time required for photographing an entire photographing range.

On the other hand, in a case in which the determination is “NO” in step S201, in step S207, it is determined whether or not poor visibility is determined in step S203 in an (n−1)-th iteration. In a case in which poor visibility is determined, the process proceeds to step S204, and in a case in which good visibility is determined, the process proceeds to step S205.

In step S205, stereo camera distance measurement (for example, the above-described image-capturing surface phase-difference camera distance measurement) is performed. This distance-measurement method differs from the stereo range-gated camera distance measurement in that light emission and exposure control synchronized with the light emission are not performed.

By exposing reflected light regardless of distance, an image in which subjects at various distances are captured can be obtained by one exposure, and the distance to each subject is measured based on the obtained image. That is, stereo camera distance measurement enables measurement of a subject with lower power consumption than stereo range-gated camera distance measurement. However, in the case of poor visibility, the distance-measurement accuracy decreases as described above.

Thus, in step S204, the light emission time of the light emitting unit and the exposure time of the image capturing unit are controlled so that the image capturing unit exposes reflected light of pulsed light within a predetermined distance range. On the other hand, in step S205, a distance to a subject is calculated based on at least the first image signal and the second image signal generated from the image capturing unit without using pulsed light.

That is, in steps S202 to S205, switching is performed between executing the processing of the above step S204 and executing the predetermined processing of the above step S205 based on a determination result of the visibility state determination unit.

In step S206, whether or not an operation for terminating travel of the moving object 300 has been performed is determined. In a case in which the operation for terminating travel has been performed, the process flow illustrated in FIG. 11 ends. In a case in which the operation for terminating travel has not been performed, step S201 in a second iteration is started.

Next, processes in and after step S201 in an n-th iteration (n≥2) will be explained with reference to FIG. 11. In step S201, it is determined whether or not the moving object has traveled Y m from the execution of step S201 in the (n−1)-th iteration. In a case in which the moving object has traveled Y m, the process proceeds to step S202, and in a case in which the moving object has not traveled Y m, the process proceeds to step S207.

Since the processes in step S202, step S203, step S204, step S205, and step S206 are as described above, explanation thereof is omitted.

In step S207, it is determined whether or not poor visibility is determined in step S203 in the (n−1)-th iteration. In a case in which poor visibility is determined, the process proceeds to step S204, and stereo range-gated camera distance measurement is performed. On the other hand, in a case in which good visibility is determined in step S207, the process proceeds to step S205, and the stereo camera distance-measurement processing is performed.

Thus, in the present embodiment, a visibility state around the vehicle is determined, and distance-measurement processing appropriate to the visibility situation can be performed.

While the present disclosure has been described with reference to embodiments, it is to be understood that the disclosure is not limited to the disclosed embodiments. The scope of the following claims is to be accorded the broadest interpretation so as to encompass all such modifications and equivalent structures and functions.

In addition, as a part or the whole of the control according to the embodiments, a computer program realizing the function of the embodiments described above may be supplied to the image capturing apparatus and the like through a network or various storage media. Then, a computer (or a CPU, an MPU, or the like) of the image capturing apparatus and the like may be configured to read and execute the program. In such a case, the program and the storage medium storing the program configure the present invention.

In addition, the present disclosure includes those realized using at least one processor or circuit configured to perform functions of the embodiments explained above. For example, a plurality of processors may be used for distribution processing to perform functions of the embodiments explained above.

This application claims the benefit of Japanese Patent Application No. 2025-008974, filed on Jan. 22, 2025, which is hereby incorporated by reference herein in its entirety.

What is claimed is:

1. An image capturing apparatus comprising:
a light emission unit configured to emit pulsed light;
an image capturing unit configured to generate at least a first image signal and a second image signal having a predetermined parallax;
at least one processor; and
a memory coupled to the at least one processor, the memory storing instructions that, when executed by the at least one processor, cause the at least one processor to:
control a light emission time of the light emission unit and an exposure time of the image capturing unit so that the image capturing unit receives reflected light of the pulsed light within a predetermined distance range;
calculate a distance value to a subject and a reliability of the distance value based on at least the first image signal and the second image signal; and
control a light emission time of the light emission unit and an exposure time of the image capturing unit so as to change a size of the distance range of at least the first image signal and the second image signal generated by the image capturing unit, based on the reliability.

2. The image capturing apparatus according to claim 1, wherein the reliability is calculated based on a variation in luminance values in a pixel group having at least the first image signal and the second image signal, or based on the variation in luminance values and an average value of the luminance values.

3. The image capturing apparatus according to claim 1, wherein, in a case in which the reliability is equal to or smaller than a predetermined threshold, a light emission time of the light emission unit and an exposure time of the image capturing unit are controlled so as to reduce the distance range.

4. The image capturing apparatus according to claim 1, wherein the light emission unit and the image capturing unit are controlled so as to increase the distance range of an image captured by the image capturing unit in one exposure, based on the reliability.

5. The image capturing apparatus according to claim 1,
wherein the memory stores further instructions that, when executed by the at least one processor, cause the at least one processor to:
determine a visibility state around the image capturing unit; and
switch between controlling a light emission time of the light emission unit and an exposure time of the image capturing unit so that the image capturing unit receives reflected light of the pulsed light within the predetermined distance range based on the determination, and executing processing for calculating a distance to a subject based on at least the first image signal and the second image signal generated by the image capturing unit without using the pulsed light.

6. The image capturing apparatus according to claim 1, wherein a size of the distance range of at least the first image signal and the second image signal generated by the image capturing unit is changed based on at least the first image signal and the second image signal having the reliability greater than a predetermined value.

7. A control method for controlling a light emission unit configured to emit pulsed light and an image capturing unit configured to generate at least a first image signal and a second image signal having a predetermined parallax, the control method comprising:
controlling a light emission time of the light emission unit and an exposure time of the image capturing unit so that the image capturing unit receives reflected light of the pulsed light within a predetermined distance range;
calculating a distance value to a subject and a reliability of the distance value based on at least the first image signal and the second image signal; and
controlling a light emission time of the light emission unit and an exposure time of the image capturing unit so as to change the size of the distance range of at least the first image signal and the second image signal generated by the image capturing unit, based on the reliability.

8. A non-transitory computer-readable storage medium storing a computer program to control a light emission unit configured to emit pulsed light and an image capturing unit configured to generate at least a first image signal and a second image signal having a predetermined parallax,
wherein the computer program comprises instructions for executing the following processes:
controlling a light emission time of the light emission unit and an exposure time of the image capturing unit so that the image capturing unit receives reflected light of the pulsed light within a predetermined distance range;
calculating a distance value to a subject and a reliability of the distance value based on at least the first image signal and the second image signal; and
controlling a light emission time of the light emission unit and an exposure time of the image capturing unit so as to change the size of the distance range of at least the first image signal and the second image signal generated by the image capturing unit, based on the reliability.
